(19) United States
(12) Patent Application Publication
(10) Pub. No.: US 2007/0017718 A1
(43) Pub. Date: Jan. 25, 2007

(54) Power systems for transportation and residential uses

(76) Inventor: Dennis S. Chrobak, Silver Lake, OH (US)

Correspondence Address: BROUSE MCDOWELL LPA, 388 SOUTH MAIN STREET, SUITE 500, AKRON, OH, 44311, US

(21) Appl. No.: 11/185,210

(22) Filed: Jul. 20, 2005

(51) Int. Cl. B60K 1/00

(52) U.S. Cl. 180/65.5

(57) ABSTRACT

A power wheel system includes a first wheel member that is attachable to a vehicle, an electric motor that selectively rotates the first wheel member and that is mounted at least partially within the first wheel member and a receiver that is attachable to the vehicle that receives wireless power from a power source, preferably electromagnetic radiation energy from the Earth's magnosphere. The power wheel system may also include a first transformer that receives an input voltage from the receiver and supplies a corresponding output voltage to the electric motor. This transformer may be positioned at least partially within the wheel member. The power wheel system may also include a control mechanism that is used to control the power wheel system. In another embodiment some of the same components can be arranged to provide a power residence system.

### I. BACKGROUND OF THE INVENTION

A. Field of Invention

This invention pertains to the art of methods and apparatuses regarding the harnessing of energy for human use and more specifically to methods and apparatuses regarding the use of electromagnetic radiation energy via wireless resources for transportation and residential energy purposes.

B. Description of the Related Art

We have an energy problem. As is now well known, the Earth's fossil fuel resources are limited. Meanwhile, energy consumption rates continue to rise. In a recent public broadcast, a spokesman indicated that Saudi Arabia cannot meet the United States oil supply requirements beyond 2015. We simply have no option but to find new sources of energy. Many people are aware of this problem and are working hard to resolve it. FIG. 1 is a table showing my analysis of the energy options before us. I call this the KROBAX MATRIX. The first column shows the nine primary energy source options. The rest of this table shows an analysis of the energy source options including the specific materials required, the conversion technologies that may be used, the primary use for the energy source, polluting levels, the business requirements (capitalization), an estimated cost per kilowatt hour (KWH) as well as my sense of the current overall rating and overall public acceptance of the energy source option. After much research and experimentation, I have discovered that electromagnetic radiation (row 8 from FIG. 1) can be efficiently harnessed to provide a readily available energy source especially for use with transportation and residential needs. My discovery uses several known technologies in a novel manner to provide power systems for use by persons anywhere on the Earth.

That the Earth's magnosphere is filled with available electromagnetic radiation energy is not debatable. A recent National Geographic article, for example, describes a solar event known as a coronal mass ejection (CME). The article notes that such CME's form very large clouds that interact with the Earth's magnetosphere and provide “trillions of watts of power into Earth's upper atmosphere.” See ‘The Sun Is The Rosetta Stone Of Astrophysics But We Haven't Been Able To Decrypt It Entirely,’ by Göran Scharmer, Institute for Solar Physics, National Geographic, July 2004. Though CMEs are rare, they clearly indicate how the sun provides immense quantities of electromagnetic radiation energy into Earth's magnosphere. In addition, mankind adds to the available energy everyday through radio and television broadcasts, cell phone activity and the like. Importantly, all this energy is free and virtually limitless.

The basic knowledge of how to transmit energy through the magnosphere is very old. Nikola Tesla, for example, in U.S. Pat. No. 685,955 issued in November 1901, provides an apparatus that can transmit and receive wireless signals. More recently, Bernard Eastlund in U.S. Pat. No. 4,686,605 issued in August 1987, describes a method and apparatus for altering a region of the Earth's magnosphere and ionosphere. This region is then excited by electron cyclotron resonance heating to increase the charged particle density. Polarized electromagnetic radiation can then be transmitted parallel to and along a field line which extends through the region. This radiation is transmitted at a frequency that excites electrons cyclotron resonance to heat and accelerate the charged particles. This increase in energy can cause ionization of neutral particles which are then absorbed as part of the region thereby increasing the charged particle density of the region. Even more recently, the High-frequency Active Auroral Research Program (HAARP) is a known scientific endeavor aimed at studying the properties and behavior of the Earth's ionosphere. The energy is available and we are beginning to understand how to use it.

With the electromagnetic radiation available in Earth's magnosphere the next issue becomes how to receive this energy in a manner that can be readily used. I have discovered a way to use the well-known rectenna for this purpose. A rectenna (RECTifying anTENNA) essentially is an antenna comprising a mesh of dipoles and diodes for absorbing microwave energy from a transmitter and converting it into electric power. I use a rectenna to take the available magnospheric energy and convert it into direct current (DC) or alternating current (AC), depending on the need. The electric power may then be converted or transformed into the appropriate voltage for use with my power systems. One recently developed technology which I have discovered to be useful for this purpose is known as a motionless electromagnetic generator (MEG). The MEG is described in U.S. Pat. No. 6,362,718 to Patrick, et al.

For one of my embodiments, especially for use with vehicles, it is still necessary to convert the energy so transformed to be used by the vehicle. Electric motor vehicles are well-known. I believe, however, that the use of such electric motors (that replace or are added on to well-known internal combustion engines (ICEs)) are not the most advantageous way to use this technology. Rather, I believe it is more efficient to provide power to the individual wheels of the vehicle. Wheeled motors are another known technology. See, for example, International Publication No. WO 01/54939 A2, which is a patent application titled, WHEEL PROVIDED WITH DRIVING MEAN. While conventional wheels may be used with my invention to provide power to vehicles, I have discovered that better results are obtained when using my own wheel designs such as those provided in U.S. Pat. No. 5,743,316, titled DYNAMIC STEERABLE WHEEL SPRING.

The present invention provides methods and apparatuses for combining known technologies in a novel manner to achieve power systems that can be used for both transportation and residential uses. I believe that these inventions enable electromagnetic radiation to be used as an acceptable new energy resource.

### II. SUMMARY OF THE INVENTION

According to one aspect of this invention, a power wheel system includes a first wheel member that is attachable to a vehicle, an electric motor that selectively rotates the first wheel member and that is mounted at least partially within the first wheel member and a receiver that is attachable to the vehicle that receives wireless power from a power source. The power wheel system may also include a first transformer that receives an input voltage from the receiver and supplies a corresponding output voltage to the electric motor. This transformer may be positioned at least partially within the wheel member. The power wheel system may also include a control mechanism which is used to control the power wheel system.

According to another aspect of this invention, the wheel member includes a first spring member that defines a plurality of fingers formed from a single section of a spring steel material, an elastomeric cap that encases ends of the fingers and an axle support bracket that is rotatable with respect to the first spring member and rotatable about a first axle of the vehicle.

According to another aspect of this invention, the receiver is a rectenna.

According to another aspect of this invention, the transformer is a motionless electromagnetic generator (MEG).

According to another aspect of this invention, a method is provided for replacing conventional wheels from a conventional automobile with a power wheel system. This method may include the steps of: (1) removing the conventional wheel; (2) mounting the power wheel system to the wheel mounting device; (3) mounting a receiver that receives wireless power and supplies input voltage to a transformer to the vehicle; and, (4) mounting a control mechanism used to control the power wheel system to the vehicle.

According to another aspect of this invention, electromagnetic radiation may be provided to a residential building such as a house or apartment in a manner that can tie into the existing electric system.

One advantage of this invention is that Earth's dependency on fossil fuels can be greatly diminished.

Another advantage of this invention is that electromagnetic radiation can be used as an energy source in an efficient and economic manner.

Another advantage of this invention is that the energy source does not create pollution.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is table showing an analysis of the Earth's energy options.

FIG. 2 is a side view of a vehicle equipped with a power wheel system according to this invention.

FIG. 3 is a front view of a house equipped with a power resident system according to this invention.

FIG. 4 is a sectional view of a power wheel system according to this invention.

FIG. 5 is a front view of a portion of the power wheel system shown in FIG. 4.

FIG. 6 is an assembly drawing showing how the power wheel system of FIGS. 4 and 5 can be attached to a conventional vehicle.

FIG. 7 is a schematic representation of several components used with the power wheel system of this invention.

FIG. 8 is a schematic representation of a power residence system according to this invention.

FIG. 9 is a perspective view of a spring member used with one embodiment power wheel system.

FIG. 10 is a perspective view of a pair of spring members used with another embodiment power wheel system.

FIG. 11 is a schematic top view of a control mechanism that may be used to control the power wheel system of this invention.

FIG. 12 is an end view of the vehicle shown in FIG. 11.

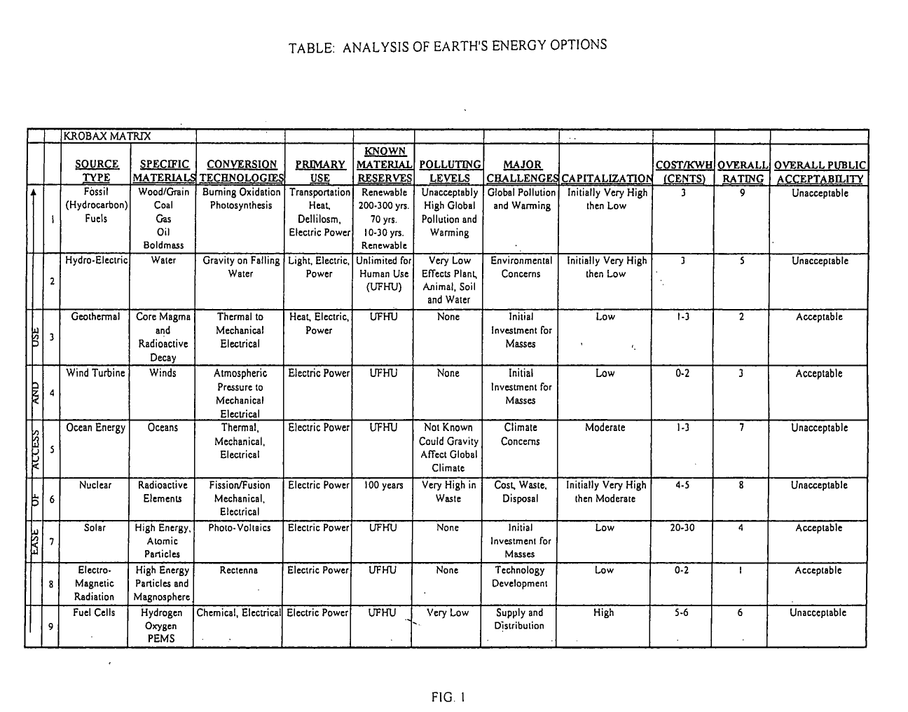

### IV. DESCRIPTION OF THE INVENTION

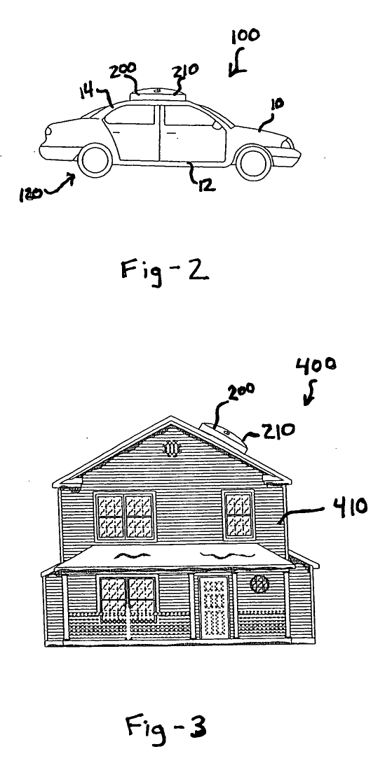

Referring now to the drawings wherein the showings are for purposes of illustrating one or more embodiments of the invention only and not for purposes of limiting the same, FIG. 2 shows a vehicle 10 equipped with the power wheel system 100 of this invention. It should be noted that while the vehicle 10 shown is an automobile, the power wheel system 100 of this invention will work well with any vehicle including trucks, buses, motorcycles, off-road vehicles, lawn mowers and the like. The vehicle 10 may have a frame 12 and a body 14 attached to the frame 12. The vehicle 10 may have all other conventional components which are well-known and, thus, will not be described in great detail here. The power wheel system 100 of this invention can be attached to a conventional vehicle, as discussed further below, or to vehicles having very different designs. Because my invention eliminates the need for ICEs, conventional electric motors, hybrid ICE/electric motors, conventional drive trains and the like, I expect that radically new vehicles will be developed to use my power wheel system 100.

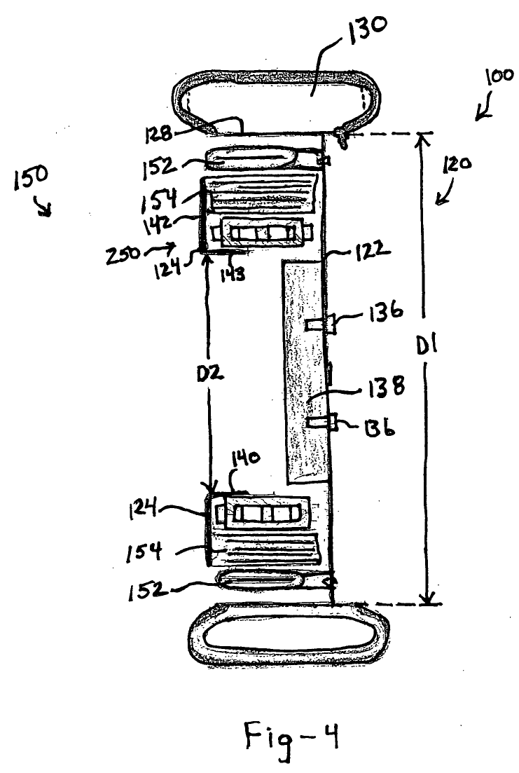

With reference now to FIGS. 2, 4 and 7, in one embodiment the power wheel system 100 includes a first wheel member 120 that is attachable to the vehicle 10 and an electric motor 150 that selectively rotates the first wheel member 120. In the embodiment shown, the electric motor 150 is mounted within the first wheel member 120. By “within the first wheel member” it is meant the space within the tire (if a conventional tire/wheel assembly is used with my invention) or within the elastomeric cap 130 (if my DYNAMIC STEERABLE WHEEL SPRING is used). In the embodiment shown, this space is defined by diameter D1, the distance between later to be described opposite fingers 128 as shown in FIG. 4. This positioning maximizes operational efficiencies and minimizes the space requirements for the components. The power wheel system 100 may also include a receiver 200 that is attachable to the vehicle 10 and that receives wireless power from a power source. Preferably this power source is electromagnetic radiation energy available from the Earth's magnosphere as described above. The power wheel system 100 may also include a transformer 250 that receives an input voltage from the receiver 200 and supplies a corresponding output voltage to the electric motor 150. The transformer 250, as shown, may be positioned within the first wheel member 120. This positioning maximizes operational efficiencies and minimizes the space requirements for the components. The power wheel system 100 may also include a control mechanism 300 which is used to control the power wheel system 100 and, thus, control the locomotion of the vehicle 10.

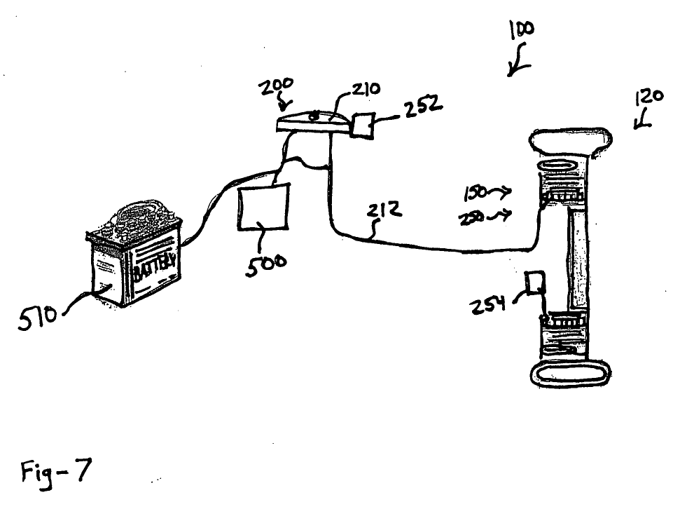

With reference now to FIGS. 2 and 7, the receiver 200 can be of any type that receives wireless power and sends it to the transformer 250. In a preferred embodiment, however, the receiver 200 is a rectenna 210. The basic operation of a rectenna 210 is known and is described above. Additional explanation is provided in U.S. Pat. No. 5,043,739, titled HIGH FREQUENCY RECTENNA, U.S. Pat. No. 5,068,669, titled POWER BEAMING SYSTEM and U.S. Pat. No. 5,503,350, titled MICROWAVE POWERED AIRCRAFT, which patents are hereby incorporated by reference. The rectenna 210 receives the wireless power from the power source and, in one embodiment, transmits it via wiring 212 to the transformer 250. In an alternate embodiment, the receiver 200 or rectenna 210 may provide wireless communication of the power to the transformer 250. A transmitter 252, for example, may wirelessly transmit power from the receiver 200 to a receiving unit 254 that then provides the power to the transformer 250. The basic operation of a wireless transmitter and receiving unit is known in the art and thus will not be described in detail.

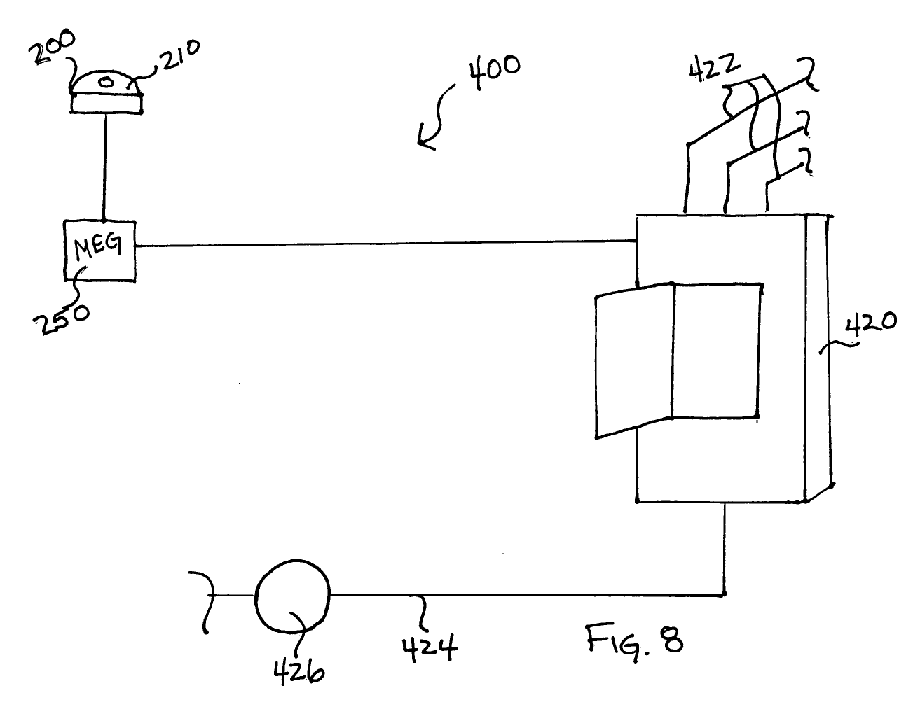

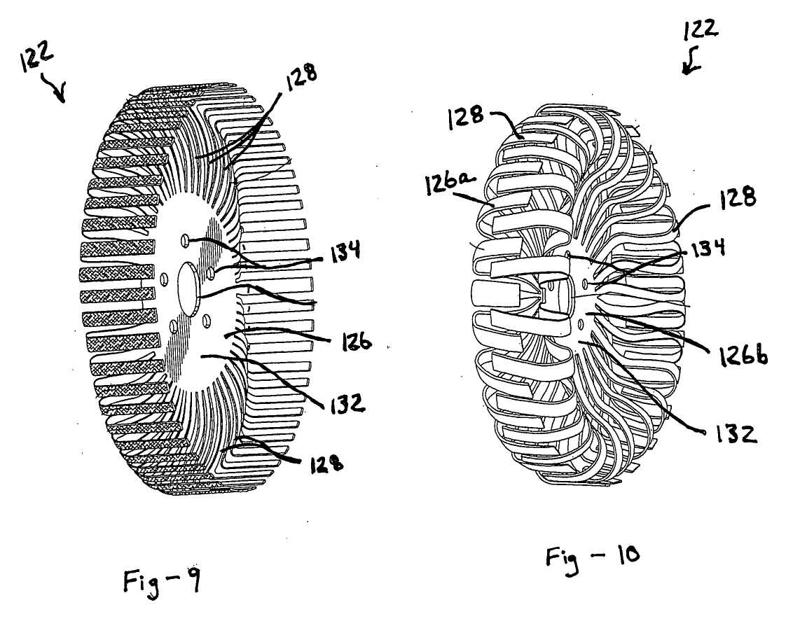

With reference now to FIGS. 2, 4-5, 7, and 9-10, the first wheel member 120 may include first and second support members 122, 124. In one embodiment, the first support member 122 comprises a spring member 126 as shown in FIG. 9. In an alternate embodiment, the first support member 122 may comprise a pair of spring members 126a, 126b as shown in FIG. 10. The spring member 126 may define a plurality of fingers 128 and be formed from a single section of a spring steel material. An elastomeric cap 130 can then be attached to the plurality of fingers 128 such that it encases the ends of the fingers 128. The spring members 126 may be formed as taught in U.S. Pat. No. 5,743,316, titled DYNAMIC STEERABLE WHEEL SPRING, which is incorporated herein by reference. For this reason, a detailed explanation of the steerable wheel spring will not be discussed here. The first support member 122 has a mid-section 132 with a number of openings 134 to receive bolts 136 to attach to a brake drum 138 which may be of conventional design. The second support member 124 may be disc-shaped having a body 142 that defines an opening 140 having a diameter D2. The second support member 124 may include an inner wall 143, extending radially from the inner edge of the body 142, as shown in FIG. 3. Alternately or in addition, an outer wall (not shown) extending radially from the outer edge of the body 142 may be included. Neither the inner or outer wall is required for my invention to work. The second support member 124 may be fixedly connected to any component of the vehicle that does not rotate with the first support member 122 in any manner chosen with sound engineering judgment. One embodiment using the vehicle suspension as the support point for the second support member 124 will be discussed below. Note that when assembled the first support member 122 rotates, along with the brake drum 138, with respect to the second support member 124. Note also that the space defined by diameter D1, the distance between opposite fingers 128 as shown in FIG. 4, is greater than is available with conventional tire/wheel assemblies. As a result, the diameter of the soon to be described rotor 152 can be about 30% larger than would be possible with a conventional tire/wheel assembly.

With reference now to FIGS. 4, 5 and 7, the electric motor 150 may include a rotor 152 and a stator 154. The rotor 152 may be mounted to the first support member 122 while the stator 154 is mounted to the second support member 124. The stator 154 receives an output voltage from the transformer 250 which is then used to rotate the rotor 152 and thus the first support member 122. Since the operation of an electric wheel is well known to those of skill in the art, further details will not be presented here. However, it should be noted that the rotor 152 is preferably fixed to the fist support member 122 in any manner chosen with sound engineering judgment. Both the stator 154 and transformer 250 are preferably fixed to the second support member 124 also in any manner chosen with sound engineering judgment. In the embodiment shown, the inner wall 143 and body 142 form a pocket into which the stator 154 and transformer 250 are positioned, as shown. This arrangement provides that the entire electric motor 150 and transformer 250 are mounted within the wheel member 120. This provides for very efficient operation.

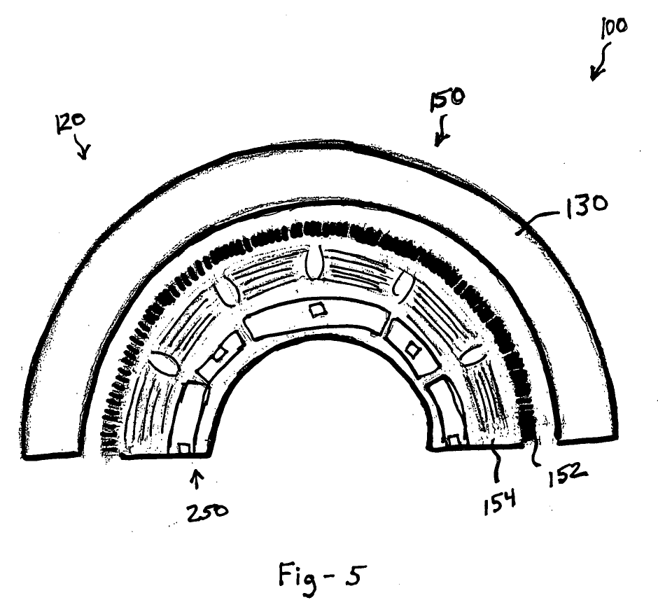

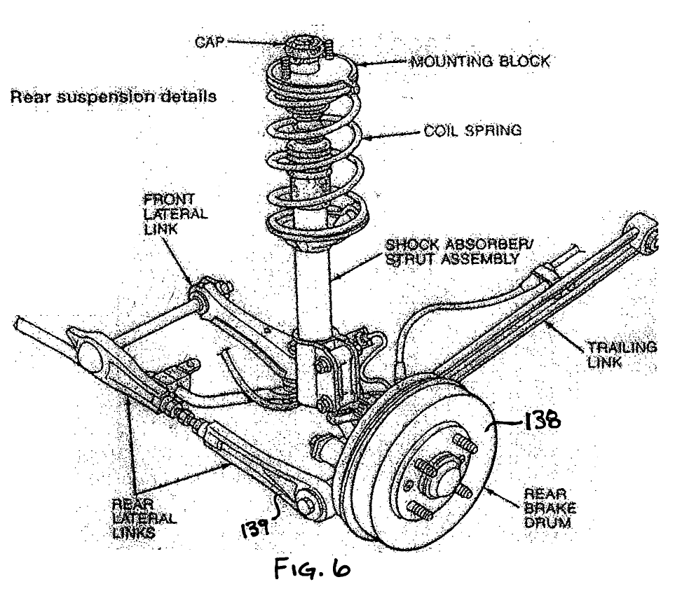

With continuing reference to FIGS. 4, 5 and 7, while the transformer 250 can be any transformer that accomplishes the transformation of voltage, in one embodiment the transformer 250 is a motionless electromagnetic generator (MEG). The operation of the MEG is provided in U.S. Pat. No. 6,362,718, titled MOTIONLESS ELECTROMAGNETIC GENERATOR, which is incorporated herein by reference. Thus, a detailed explanation of the operation of the MEG will not be provided here. However, it should be noted that the MEG can boost voltage by a factor of 60. Thus, for example, the MEG will boost a 75 volt input to a 4500 volt output. The use of the MEG eliminates any need for a vast battery bank that is required in conventional electric vehicles. I have discovered that the preferred transformer 250 defines an arc and more preferably substantially a circle, as shown in FIG. 5, to provide the best voltage transformation to the stator 154. In anther embodiment, the transformer (whether MEG or otherwise) may be formed without the use of permanent magnets such as a wound bi-pole coil.

While the particular sizes and capacities of the various components discussed thus far may vary according to the particular vehicle, I have discovered that the following sizes and capacities provide sufficient power for a typical small automobile, such as a Ford Escort Wagon:
Tire: 24 inches×7.5 inches—19 DSS/AH/SSTHS
Wheel: 19 inches×5.5 inches—½ inch Bolt Holes on 4.25 inch center
Stator: 12 inch ID and about 4.5×4.5 inch Permanent Magnets (or wound bi-pole coils)—AC Synchronous—Series—No Sack EMF
Rotor: 17 inches OD×4.75 inches with ASO turns 1 mm Wire with rotating commutator/slip ring
MEG: Delivers 500 volt output with 8.3 volt input (input from battery or rectenna)
Electric Motor: produces 200 horse power (HP) or 148.2 KW with 1.65 ohm resistance with 311 amperes; will operate from 0 to 1800 rounds per minute (RPM) and cruise at 700 to 1000 RPM; will provide up to 150 pound—feet of torque

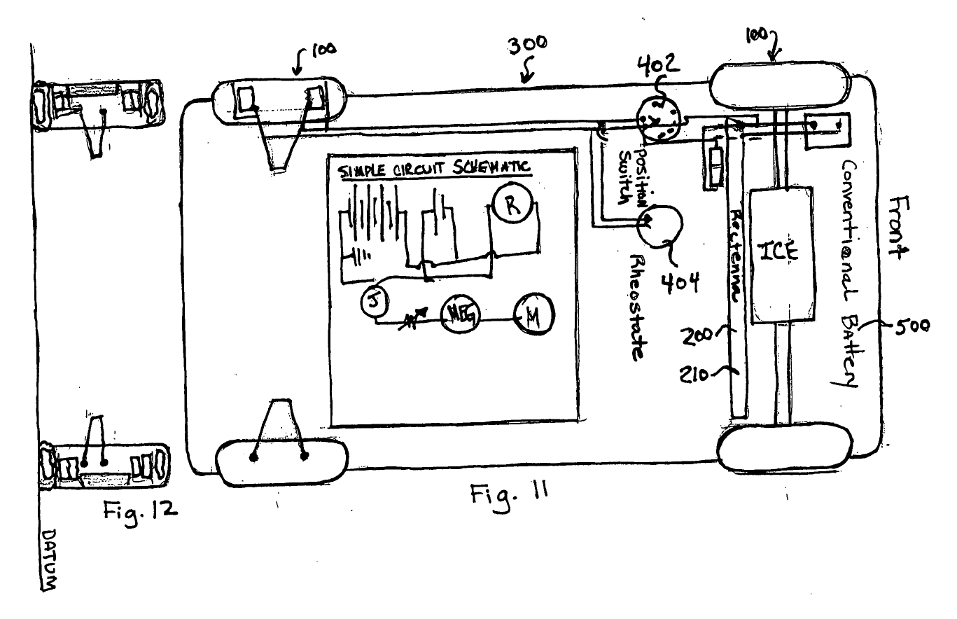

With reference now to FIGS. 7, 11 and 12, one embodiment control mechanism 300 used to control one or more power wheel systems 100 will be described. As noted above, the power wheel system 100 is independent of the conventional ICE. It also may be independent of the conventional braking system. The receiver 200 provides continuous power to an on-board power storage device 500, such as a conventional battery 510 or replaceable dry cells. The power storage device 500 may be positioned in the vehicles driver's compartment, as shown in FIG. 11. The power storage device 500 then provides power to the transformer as discussed above. The control mechanism 300 may include a position switch 402 and a rheostat 404 to control current flow to the one or more power wheel systems 100. The battery 510 may serve the function of a backup power source in the event that power from the receiver 200 is not provided to the transformer 250.

With reference now to FIGS. 2,4, 6, 7, 11 and 12, in one embodiment, the power wheel system 100 of this invention can be used with a conventional automobile. In this case, the conventional wheel of the vehicle is removed and the power wheel system 100 according to this invention is mounted in its place. In one embodiment, after the stator 154 and transformer 250 are mounted to the second support member 124, the second support member 124 is positioned such that the brake drum 138 is received within the opening 140 (thus diameter D2 is preferably greater than the outer diameter of the brake drum 138). The second support member 124 is then fixedly attached to at least one, preferably two, lateral links 139. It should be understood that this is just one embodiment because the second support member 124 can be fixedly connected to any component of the vehicle that does not rotate with the first support member 122. The first support member 122 is then attached to the brake drum 138 as described above. This attachment of the first support member 122 is very similar to the attachment of a conventional tire/wheel assembly to a brake drum 138. Next, the receiver 200, which may be a rectenna 210, is mounted to the vehicle 10 and the receiver 200 is electrically attached to the transformer 250. Finally, the control system 300 is also attached to the vehicle 10, as described above.

With reference now to FIGS. 3 and 8, in another embodiment some of the same components can be arranged to provide for a power residence system 400. In this case, the receiver 200, which may be a rectenna 210, is mounted to a home or other dwelling place 410. The power received by the receiver 200 is then transferred via wires or wirelessly to a transformer 250, preferably a MEG. Preferably, but this is not a requirement, the MEG is positioned within the dwelling place 410. Power is then transferred either via wires or wirelessly to a conventional junction box 420 where it is then transferred throughout the dwelling place 410 via wires 422 in the conventional manner. In cases where the power residence system 400 is being added to a dwelling place 410 that already receives power via wiring 424 from a conventional power source, such as an electric utility company, an electric switch 426 may be added to the circuitry. In this way, the switch may be placed into the open position (no current flow through wiring 424) when power is provided by the power residence system 400. The conventional power source may serve the function of a backup power source in the event that power from the receiver 200 is not provided to the transformer 250 by simply closing the electric switch 426.

One or more embodiments of this invention have been described, hereinabove. It will be apparent to those skilled in the art that the above apparatuses and methods may incorporate changes and modifications without departing from the general scope of this invention. It is intended to include all such modifications and alterations in so far as they come within the scope of the appended claims or the equivalents thereof.

Having thus described the invention, it is now claimed:

I claim:

1. A power wheel system comprising:
a first wheel member comprising: (a) a first support member comprising a first spring member defining a plurality of fingers formed from a single section of a spring steel material; (b) an elastomeric cap that encases ends of the plurality of fingers; and, (c) a second support member attachable to a vehicle and selectively rotatable with respect to the first spring member;
a first motionless electromagnetic generator mounted to the second support member and defining at least a portion of an arc, the first motionless electromagnetic generator receiving an input voltage and supplying a corresponding output voltage;
a first electric motor that selectively rotates the first wheel member to propel the vehicle comprising: (a) a rotor mounted to the first support member; and, (b) a stator mounted to the second support member and comprising a plurality of permanent magnets, the stator being positioned substantially between the rotor and the first motionless electromagnetic generator, the stator receiving the output voltage from the first motionless electromagnetic generator;
a rectenna attachable to the vehicle, the rectenna receiving wireless power from a power source and supplying the input voltage to the first motionless electromagnetic generator; and,
a control mechanism used to control the power wheel system.

2. The power wheel system of claim 1 further comprising:
a power storage device that stores power from the rectenna and that selectively supplies the input voltage to the first motionless electromagnetic generator.

3. The power wheel system of claim 1 wherein the vehicle has a battery and the battery selectively supplies the input voltage to the first motionless electromagnetic generator.

4. The power wheel system of claim 3 wherein the battery is a conventional vehicle battery.

5. The power wheel system of claim 1 wherein the first wheel member further comprises:
a second spring member defining a plurality of fingers formed from a single section of a spring steel material; and,
wherein the elastomeric cap encases ends of the plurality of fingers of the second spring member.

6. The power wheel system of claim 1 wherein the first motionless electromagnetic generator substantially defines a circle.

7. The power wheel system of claim 1 further comprising:
a second wheel member comprising: (a) a first support member comprising a first spring member defining a plurality of fingers formed from a single section of a spring steel material; (b) an elastomeric cap that encases ends of the plurality of fingers; and, (c) a second support member attachable to a vehicle and selectively rotatable with respect to the first spring member;
a second motionless electromagnetic generator mounted to the second support member of the second wheel member and defining at least a portion of an arc, the second motionless electromagnetic generator receiving an input voltage and supplying a corresponding output voltage;
a second electric motor that selectively rotates the second wheel member to propel the vehicle comprising: (a) a rotor mounted to the second support member of the second wheel member; and, (b) a stator mounted to the first support member of the second wheel member and comprising a plurality of permanent magnets, the stator being positioned substantially between the rotor and the second motionless electromagnetic generator, the stator receiving the output voltage from the second motionless electromagnetic generator;
wherein the rectenna supplies the input voltage to the second motionless electromagnetic generator.

8. A power wheel system comprising:
a first wheel member attachable to a vehicle;
a first electric motor that selectively rotates the first wheel member and that is mounted at least partially within the first wheel member;
a receiver, attachable to the vehicle, that receives wireless power from a power source;
a first transformer that receives an input voltage from the receiver and supplies a corresponding output voltage to the first electric motor; the first transformer being positioned at least partially within the wheel member; and,
a control mechanism used to control the power wheel system.

9. The power wheel system of claim 8 wherein the first wheel member comprises:
a first support member comprising a first spring member defining a plurality of fingers formed from a single section of a spring steel material;
an elastomeric cap that encases ends of the plurality of fingers; and,
a second support member selectively rotatable with respect to the first spring member and attachable to the vehicle.

10. The power wheel system of claim 8 wherein the receiver is a rectenna.

11. The power wheel system of claim 8 wherein:
the first wheel member comprises:
(a) a first support member comprising a first spring member; and
(b) a second support member selectively rotatable with respect to the first spring member and selectively attachable to the vehicle; and,
the first electric motor comprises:
(a) a rotor mounted to the first support member; and,
(b) a stator mounted to the second support member, the stator receiving the output voltage from the first transformer.

12. The power wheel system of claim 11 wherein the stator comprises a plurality of permanent magnets and the stator is positioned substantially between the rotor and the first transformer.

13. The power wheel system of claim 8 wherein the first transformer is a motionless electromagnetic generator.

14. The power wheel system of claim 13 wherein the motionless electromagnetic generator defines an arc.

15. The power wheel system of claim 14 wherein the motionless electromagnetic generator substantially defines a circle.

16. The power wheel system of claim 8 further comprising:
a power storage device that stores power from the receiver and that selectively supplies the input voltage to the first transformer.

17. The power wheel system of claim 8 wherein the vehicle has a battery and the battery selectively supplies the input voltage to the first transformer.

18. A method comprising the steps of:
providing a conventional automobile having at least a first wheel mounted on a first wheel mounting device;
providing a power wheel system comprising: (a) a wheel member; (b) an electric motor that selectively rotates the wheel member and that is mounted at least partially within the wheel member; and, (c) a transformer that receives an input voltage and that supplies a corresponding output voltage to the electric motor, the transformer being positioned at least partially within the wheel member;
removing the first wheel from the first wheel mounting device;
mounting the power wheel system to the first wheel mounting device;
mounting a receiver that receives wireless power from a power source and supplies the input voltage to the transformer to the vehicle; and,
mounting a control mechanism used to control the power wheel system to the vehicle.

19. The method of claim 18 wherein the power wheel system further comprises a first support member having a stator attached thereto and a second support member having a stator and the transformer attached thereto, the step of, mounting the power wheel system to the first wheel mounting device, comprises the steps of:
fixedly attaching the second support member to the automobile; and,
attaching the first support member to the first wheel mounting device.

20. The method of claim 19 wherein the second support member has an opening, wherein prior to the step of, fixedly attaching the second support member to the automobile, the method comprises the step of:
positioning the second support member such that the first wheel device is received within the opening.
